(19) United States
(12) Patent Application Publication
(10) Pub. No.: US 2026/0137040 A1
(43) Pub. Date: May 21, 2026

(54) ONE-TO-MANY HYDROPONICS SYSTEM

(71) Applicant: HARVATEK CORPORATION, Hsinchu City (TW)

(72) Inventors: SUNG-YI HSIAO, MIAOLI COUNTY (TW); CHIA-CHIN CHEN, Hsinchu City (TW); PING-LUNG WANG, HSINCHU CITY (TW)

(21) Appl. No.: 19/019,334

(22) Filed: Jan. 13, 2025

(30) Foreign Application Priority Data
Nov. 15, 2024 (TW) 113212486

(51) Int. Cl. A01G 31/00; A01G 31/02

(52) U.S. Cl. CPC A01G 31/011; A01G 31/065

(57) ABSTRACT

A one-to-many hydroponics system includes a main system, a plurality of sub-systems, and a circulation pipe system. The main system is configured to cooperate with the sub-systems through the circulation pipe system. Each of the sub-systems includes at least one hydroponics region and a solution storage region, and the solution storage region is configure to store a nutrient solution and supply the nutrient solution to the at least one hydroponics region. The main system includes a nutrient solution preparing device, a water quality analysis device, and a dosing device. The nutrient solution preparing device is in fluid communication with the solution storage region of each of the sub-systems. The water quality analysis device is in fluid communication with the circulation pipe system. The dosing device is in fluid communication with the nutrient solution preparing device.

### CROSS-REFERENCE TO RELATED PATENT APPLICATION

This application claims the benefit of priority to Taiwan Patent Application No. 113212486, filed on Nov. 15, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a hydroponics system, and more particularly to a one-to-many hydroponics system capable of managing a plurality groups of hydroponic plants at the same time.

### BACKGROUND OF THE DISCLOSURE

Hydroponics is a technology of growing plants without soil. In such technology, nutrient solution, in which roots of the plants are soaked, is used as a medium of supplying nutrition to the plants, and other material for supporting the roots of the plants can be provided in some specific circumstances. Therefore, in the technology of hydroponics, conditions of the nutrient solution (such as conductivity, pH value, dissolved oxygen amount, and etc.) should be properly monitored and adjusted, so that the nutrient solution is maintained in a state suitable for growing the plants.

Mostly, operations of monitoring and controlling quality of the nutrient solution known in the prior arts are conducted artificially, which is laborious and time-consuming. Although systems or apparatus for automatically managing the quality of the nutrient solution of hydroponics have also been developed, these known systems and apparatus can only control one single set of parameters. In other words, one system or apparatus can monitor nutrient solution conditions for only one type of the plant. If different types of the plants are to be grown in a hydroponics system, and nutrition ingredients of the nutrient solution of these types of the plants significantly varies, the known system or apparatus can only select the nutrition parameters of only one type of the plants as a basis of monitoring, and cannot take all requirements of the nutrient solution of each type of the plants into account.

Hence, the known arts still cannot solve the difficulty in the technology of hydroponics of monitoring and adjusting the nutrient solution for plural types of the plants at the same time.

### SUMMARY OF THE DISCLOSURE

In response to the above-referenced technical inadequacy, the present disclosure provides a one-to-many hydroponics system, which can achieve the goal of managing the conditions of the nutrient solution for plural types of the plants at the same time by the control and connection between a main system and a plurality of sub-systems. In this way, the planting area can be expanded without consuming additional labor cost, and the production efficiency can be increased.

In order to solve the above-mentioned problems, one of the technical aspects adopted by the present disclosure is to provide a one-to-many hydroponics system, which includes a main system, a plurality of sub-systems, and a circulation pipe system. The main system is configured to cooperate with the sub-systems through the circulation pipe system. Each of the sub-systems includes at least one hydroponics region and a solution storage region, and the solution storage is configured to store nutrient solution and to supply the nutrient solution to the at least one hydroponics region. The main system includes a nutrient solution preparing device, a water quality analysis device, a dosing device, and a control module. The nutrient solution preparing device is in fluid communication with the solution storage region of each of the sub-systems through the circulation pipe system, so as to recycle the nutrient solution which has been used in any one of the sub-systems. The water quality analysis device is in fluid communication with the circulation pipe system, so as to analyze quality parameters of the recycled nutrient solution. The dosing device is in fluid communication with the nutrient solution preparing device, so as to supply nutrition to the recycled nutrient solution according to the quality parameters. The control module is in signal communication with the dosing device and the water quality analysis device.

In one of the possible or preferred embodiments, the dosing device further includes at least one nutrition supplier, an acid supplier, an alkali supplier, and a dosing pipe system. The at least one nutrition supplier, the acid supplier, and the alkali supplier are in fluid communication with the nutrient solution preparing device through the dosing pipe system, and the dosing pipe system is provided with a dosing pump.

In one of the possible or preferred embodiments, the nutrient solution preparing device includes a mixing tank and a stirring device disposed in the mixing tank. The at least one nutrition supplier, the acid supplier, and the alkali supplier are in fluid communication with the mixing tank through the dosing pipe system, so as to mix at least one nutrition, an acid, and/or an alkali fed into the mixing tank with the recycled nutrient solution through an operation of the dosing pump.

In one of the possible or preferred embodiments, the circulation pipe system includes a first circulation pipe, a plurality of branch pipes, and a first circulation pump. The first circulation pipe is connected to the mixing tank to form a main circulation loop. The branch pipes extend from the first circulation pipe, and are respectively in fluid communication with the solution storage regions of the sub-systems. The first circulation pump is installed on the first circulation pipe. The water quality analysis device is in fluid communication with the first circulation pipe through a sampling pipe.

In one of the possible or preferred embodiments, each of the sub-systems includes a second circulation pipe and a second circulation pump. The second circulation pipe is connected to the at least one hydroponics region to form a secondary circulation loop, and the second circulation pump is installed on the second circulation pipe, so as to circulate the nutrient solution between the solution storage region and the at least one hydroponics region.

In one of the possible or preferred embodiments, each of the sub-systems includes at least one growing light source, and the at least one growing light source is configured to irradiate the at least one hydroponics region, so as to provide an optical wavelength for growing the plant.

In one of the possible or preferred embodiments, each of the sub-systems includes at least one air flow generator, and the at least one air flow generator corresponds in position to the at least one hydroponics region.

In one of the possible or preferred embodiments, each of the sub-systems includes at least one image capturing device, and the at least one image capturing device corresponds in position to the at least one hydroponics region, so as to capture images of the plant.

In one of the possible or preferred embodiments, each of the sub-systems includes a sensing module which includes an air temperature and humidity sensor, a carbon dioxide concentration sensor, and a water temperature sensor, so as to monitor growing environment parameters of the plant.

In one of the possible or preferred embodiments, the plant growing in the at least one hydroponics region of one of the sub-systems is different from the plant growing in the at least one hydroponics region of another one of the sub-systems.

In one of the possible or preferred embodiments, the main system is in fluid communication with an external pure water source, and the nutrient solution preparing device is configured to receive pure water for preparing the nutrient solution.

In one of the possible or preferred embodiments, the first circulation pump is connected to an external waste water pipe, so that when the nutrient solution in at least one of the sub-systems becomes unsuitable for use, the nutrient solution is discharged from the at least one of the sub-systems through the external waste water pipe.

In conclusion, in the one-to-many hydroponics system provided by the present disclosure can realize a one-to-many planting management, in which a planting area can be expanded without additional manpower costs by an automatic system for monitoring and adjusting a nutrient solution. The aforementioned beneficial effects can be achieved by the technical features as follows: the one-to-many hydroponics system includes a main system, a plurality of sub-systems, and a circulation pipe system, the main system is configured to cooperate with the sub-systems through the circulation pipe system, each of the sub-systems includes at least one hydroponics region and a solution storage region that is configured to store nutrient solution and supply the nutrient solution to the at least one hydroponics region. Specifically, the main system includes a nutrient solution preparing device, a water quality analysis device, a dosing device, and a control module. The nutrient solution preparing device is in fluid communication with the solution storage region of each of the sub-systems through the circulation pipe system, so as to recycle the nutrient solution which has been used in any one of the sub-systems. The water quality analysis device is in fluid communication with the circulation pipe system, so as to analyze quality parameters of the recycled nutrient solution. The dosing device is in fluid communication with the nutrient solution preparing device, so as to adjust a nutrition concentration of the recycled nutrient solution according to the quality parameters. The control module is in signal communication with the dosing device and the water quality analysis device.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a block diagram of a hydroponics system according to one embodiment of the present disclosure;

FIG. 2 is a block diagram of a main system and a sub-system of the hydroponics system according to one embodiment of the present disclosure;

FIG. 3 is a block diagram of a circulation pipe system and sub-systems according to another embodiment of the present disclosure;

FIG. 4 is an operational block diagram of the hydroponics system of the present disclosure conducting initial nutrient solution preparation and delivering the nutrient solution to a sub-system;

FIG. 5 is an operational block diagram of the hydroponics system of the present disclosure inspecting the nutrient solution in a sub-system;

FIG. 6 is an operational block diagram of the hydroponics system of the present disclosure adjusting the nutrient solution in a sub-system.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### Embodiments

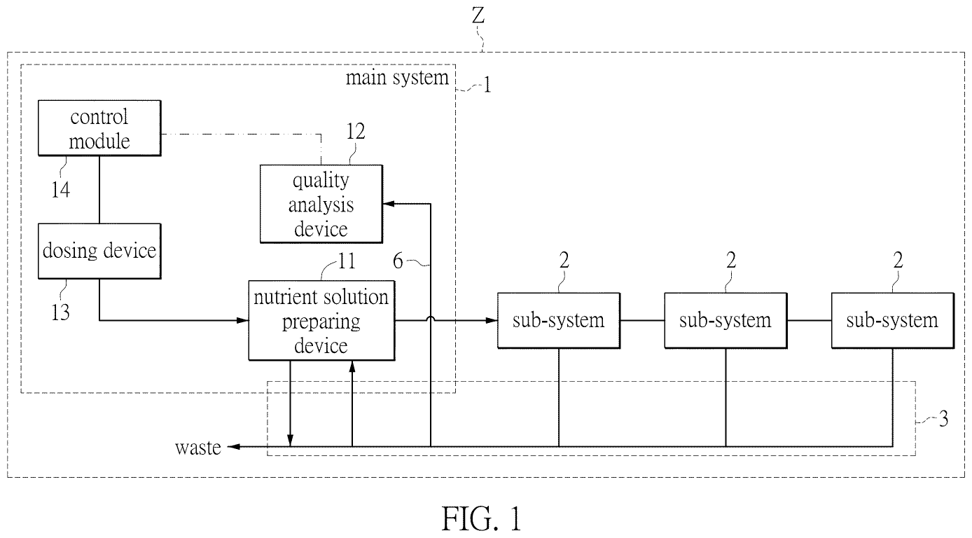

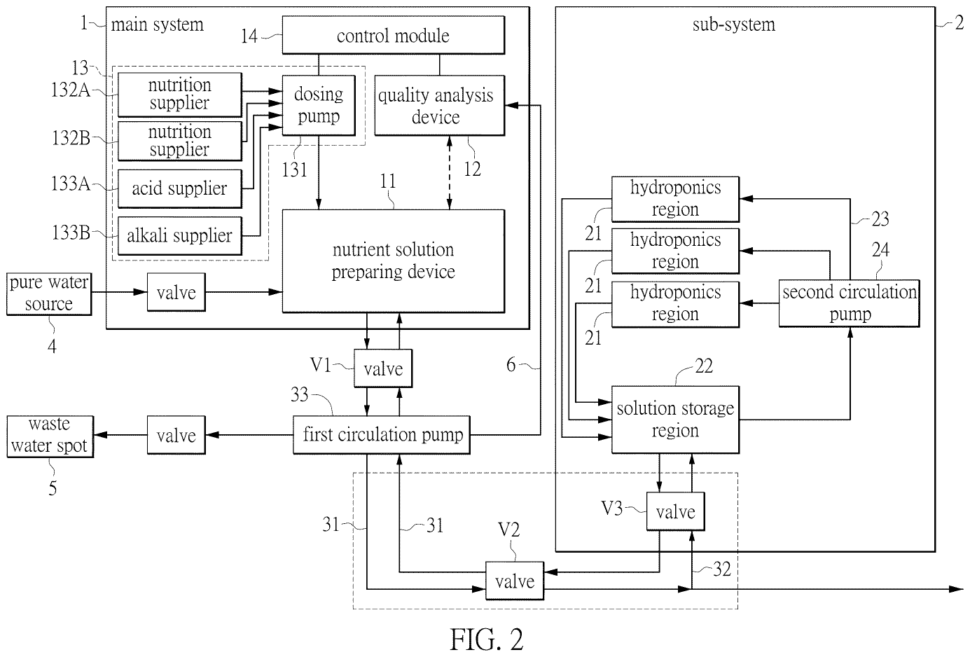

Referring to FIG. 1 and FIG. 2, a block diagram of a one-to-many hydroponics system Z of the present disclosure and a block diagram of a main system, a sub-system, and a circulation pipe system are shown. The hydroponics system Z includes a main system 1, a plurality of sub-systems 2 planted with hydroponic plants, and a circulation pipe system 3. The main system 1 is connected to the sub-systems 2 through the circulation pipe system 3, such that the main system 1 is configured to cooperate with the sub-systems 2, so as to conduct monitoring and adjusting operations of a nutrient solution for the hydroponics plants.

Each of the sub-systems 2 includes at least one hydroponics region 21 and a solution storage region 22, and each of the sub-systems 2 can have the same or different plants planted therein. In certain embodiments, each of the sub-systems 2 can be a shelf having a plurality of layered compartments, and the hydroponics regions 21 can be correspondingly arranged in the compartments. Each of the hydroponics regions 21 has an accommodation space for accommodating a nutrient solution and the plants. The number of the hydroponics regions 21 is not limited, and can be increased or decreased according to a required planting scale. The solution storage region 22 is arranged at a bottom of the shelf for storing the nutrient solution for hydroponics and supplying the nutrient solution to each of the hydroponics regions 21. Specifically, each of the sub-systems 2 further includes a second circulation pipe 23 and a second circulation pump 24. The solution storage region 22 is in fluid communication with each of the hydroponics region 21 through the second circulation pipe 23, thereby forming a closed fluid loop. The second circulation pump 24 is installed on the second circulation pipe 23. By the driving of the second circulation pump 24, the nutrient solution can be circulated between the solution storage region 22 and each of the hydroponics regions 21 through the second circulation pipe 23.

In some embodiment, the second circulation pump 24 can be in signal communication with a control module 14 of the main system 1, such that the control module 14 can start or stop the operation of the second circulation pump 24. For example, the control module 14 is configured to control the second circulation pump 24 to operate for a circulation time period, so as to circulate the nutrient solution between the solution storage region 22 and each of the hydroponics regions 21 within the circulation time period. Alternatively, the second circulation pump 24 can be turned off after the circulation time period has passed, and the nutrient solution is then maintained static in the solution storage region 22 and each of the hydroponics regions 21 for a static time period.

The main system 1 includes a nutrient solution preparing device 11, a water quality analysis device 12, a dosing device 13, and the control module 14. The control module 14 is in signal communication with the water quality analysis device 12 and the dosing device 13, and can receive signals from or send control commands to the water quality analysis device 12 and the dosing device 13. The control module 14 also includes a memory for storing information sent by other components of the hydroponics system Z, such as conductivity, pH values, dissolved oxygen amounts of the nutrient solution, environmental temperatures, record times, and plant growth images. The nutrient solution preparing device 11 is in fluid communication with the solution storage region 22 of each of the sub-systems 2 through the circulation pipe system 3, such that the nutrient solution which has been used in the solution storage region 22 can be recycled to the nutrient solution preparing device 11 for preparation, or the prepared nutrient solution in the nutrient solution preparing device 11 can be delivered to the solution storage region 22. In certain embodiments, the nutrient solution preparing device 11 includes a mixing tank and a stirring device. The mixing tank is used for accommodating the nutrient solution to be prepared, and the stirring device is used for mixing the nutrient solution.

The water quality analysis device 12 is in fluid communication with the solution storage region 22 of each of the sub-systems 2 through the circulation pipe system 3 to extract at least a portion of the nutrient solution in the solution storage region 22 for water quality analysis, so as to acquire water quality parameters of the nutrient solution. The water quality parameters are then transmitted to the control module 14 for analysis and storage.

The dosing device 13 is in fluid communication with the nutrient solution preparing device 11, and can adjust the quality of the nutrient solution in the nutrient solution preparing device 11 according to the quality parameters obtained by the water quality analysis device 12. Specifically, the dosing device 13 includes a dosing pump 131, at least two nutrition suppliers 132A, 132B, an acid supplier 133A, an alkali supplier 133B, and a dosing pipe system. The nutrition supplier 132A and the nutrition supplier 132B are respectively store nutrition solutions with different ingredient combinations, and the acid supplier 133A and the alkali supplier 133B are respectively store an acid solution and an alkali solution. The nutrition suppliers 132A, 132B, the acid supplier 133A, and the alkali supplier 133B are all in fluid communication with the nutrient solution preparing device 11 through the dosing pipe system, and the dosing pump 131 is installed on the dosing pipe system. In this way, when the control module 14 determines that the nutrient solution needs to be re-prepared according to the water quality analysis device 12, it control the dosing pump 131 to pump the nutrition solutions in the nutrition suppliers 132A, 132B and/or pump the acid solution in the acid supplier 133A and the alkali solution in the alkali supplier 133B to the nutrient solution preparing device 11 for nutrient solution preparation. It should be understood that although in the present embodiment, two nutrition suppliers 132A, 132B are taken as an example for description, the number and types of the nutrition suppliers are not limited, and can be increased or decreased based on practical requirements.

Furthermore, in certain embodiments, the nutrient solution preparing device 11 is in fluid communication with a pure water source 4, so as to receive pure water for preparing or diluting the nutrient solution.

The circulation pipe system 3 includes a first circulation pipe 31, at least one branch pipe 32, and a first circulation pump 33. The first circulation pipe 31 is connected to the nutrient solution preparing device 11 and extends therefrom. The at least one branch pipe 32 branches from the first circulation pipe 31, and is connected to the solution storage region 22 of each of the sub-systems 2. The first circulation pump 33 is used for driving a fluid flow between the main system 1 and each of the sub-systems 2, and is installed on the first circulation pipe 31 and located between the nutrient solution preparing device 11 and the first one of a plurality of branch pipes 32 (i.e., the branch pipe 32 extends to the sub-system 2 closest to the main system 1 from the first circulation pipe 31).

Moreover, a sampling pipe 6 is disposed between the first circulation pump 33 and the water quality analysis device 12, such that the nutrient solution can flow to the water quality analysis device 12 from the solution storage 22 through the sampling pipe 6, so as to conduct quality analysis to the nutrient solution in the solution storage region 22 of each of the sub-systems 2.

In addition, in certain embodiments, the circulation pipe system 3 further includes a plurality of valves for controlling fluid communication of the pipes. For example, a first valve V1 can be disposed on the first circulation pipe 31 and between the nutrient solution preparing device 11 and the first circulation pump 33, so as to control the fluid communication between the nutrient solution preparing device 11 and the first circulation pump 33. Furthermore, a second valve V2 can be disposed between the first circulation pump 33 and the first one of the branch pipes 32, so as to control the fluid communication between the main system 1 and each of the branch pipes 32. In addition, a third valve V3 can be disposed on each of the branch pipes 32, so as to control the fluid communication between each of the sub-systems 2 and the first circulation pipe 31.

Furthermore, in certain embodiments, the first circulation pump 33 is in fluid communication with a waste water place 5 through a waste water pipe, so as to discharge the nutrient solution which cannot be recycled for use once more in the solution storage region 22 of any one of the sub-systems 2.

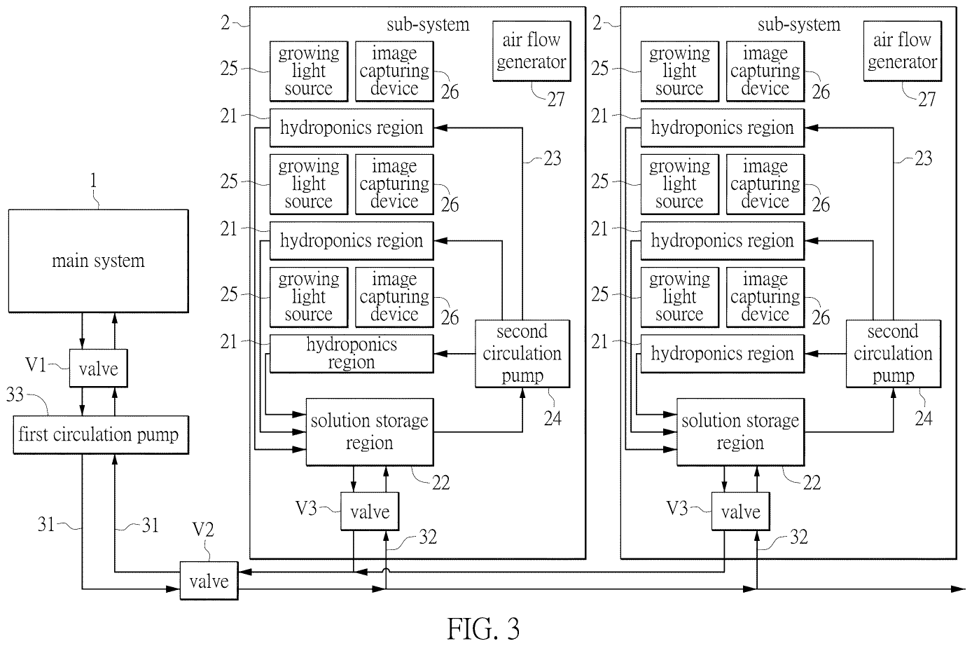

Reference is now made to FIG. 3, which shows a block diagram of the circulation pipe system 3 and the sub-systems 2 of another embodiment of the present disclosure. It should be understood that for better illustration and explanation, components and structure included in the main system 1 are omitted in FIG. 3, and the main system 1 is represented by a single block. However, the main system 1 of the embodiment illustrated in FIG. 3 can still include the components and structural features described above.

In the embodiment shown in FIG. 3, each of the sub-systems 2 can further includes additional apparatus for environment monitoring and adjusting, such as a growing light source 25, an image capturing device 26, and an air flow generator 27. The growing light source 25 and the image capturing device 26 are disposed in the hydroponics regions 21. The air flow generator 27 can corresponds in position to each of the hydroponics regions 21 according to the way of disposing the growing light source 25 and the image capturing device 26. Alternatively, as shown in FIG. 3, the air flow generator 27 can be disposed in such a manner that the plurality of the hydroponics regions 21 share one air flow generator 27 (i.e., one of the sub-systems 2 includes only one air flow generator 27). In addition, each of the sub-systems 2 includes a sensing module (not illustrated) which is configured to cooperate with actions of the apparatus for environment monitoring and adjusting. The sensing module can at least include an air temperature and humidity sensor, a carbon dioxide concentration sensor, a water temperature sensor, or includes other types of sensors.

The growing light source 25 includes at least one light emitting unit disposed in the hydroponics region 21, and the at least one light emitting unit is preferably disposed above each of the hydroponics regions 21, so as to irradiate the plants in the hydroponics regions 21 and provide an optical wavelength for growing the plants. The growing light source 25 is in signal communication with the control module 14 of the main system 1, such that the growing light source 25 can be turned on or off by the control module 14. For example, the control module 14 can be set to turn on or off the light emitting unit after a specific time period has passed, so as to irradiate the plants regularly.

The image capturing device 26 includes at least one photographing unit. The photographing unit is preferably disposed at the same height with the plants in the hydroponics regions 21, or above the plants, so as to record the plants or take a photo for the plants as growth experience information of the plants. The photographing unit is further configured to shoot at a specific time interval (such as several hours, days, weeks, or months). The image capturing device 26 is in signal communication with the control module 14 of the main system 1, so as to transmit the photos or videos of the plants shot by the photographing unit to the control module 14.

The air flow generator 27 includes at least one fan unit that is disposed near the shelf of the sub-system 2 or near each of the hydroponics regions 21. The air flow generator 27 can be used in cooperation with the air temperature and humidity sensor of the sensing module, which is configured to sense environmental temperatures in the sub-system 2 (i.e., temperatures of an environment where the plants grow in the hydroponics region 21). The air temperature and humidity sensor is in signal communication with the control module 14 of the main system 1, so as to transmit sensed temperature information of the sub-system 2 to the control module 14. The fan unit can be turned on or off by the control module 14. For example, when an environmental temperature sensed by the air temperature and humidity sensor is higher than an ideal environment temperature set in the control module 14, the control module 14 can turn on the fan unit to perform a cooling operation with blowing air. On the other hand, when an environmental temperature sensed by the air temperature and humidity sensor is lower than the ideal environment temperature, the control module 14 can turn off the fan unit to stop the cooling operation with blowing air. Alternatively, the control module is configured to turn on or off the fan unit after a specific time period has been passed, so as to realize regular cooling in the sub-systems 2.

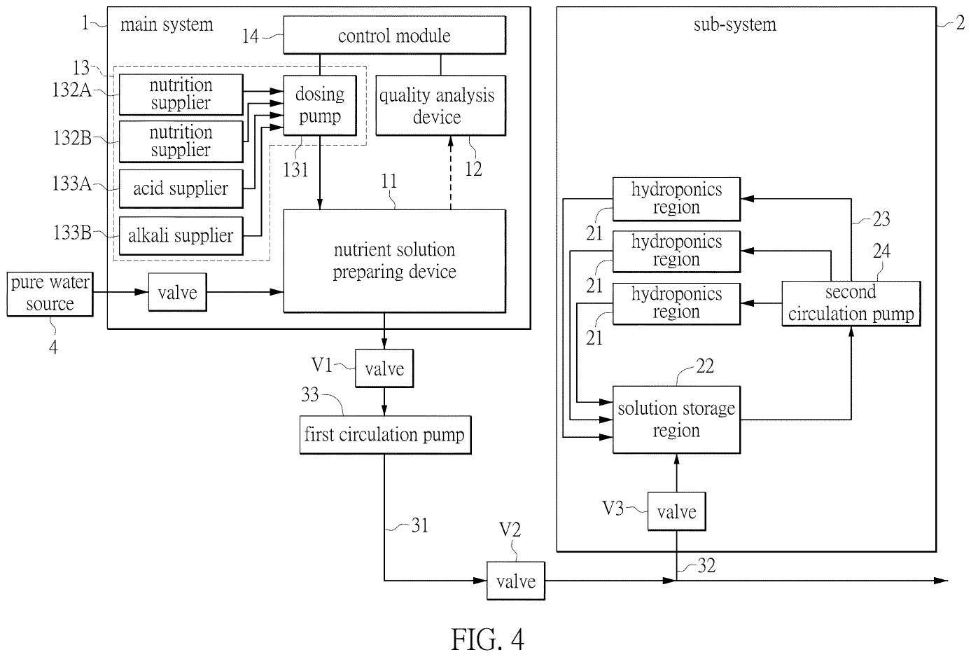

The following will describe operations of the hydroponics system Z of the present disclosure. Referring to FIG. 4 to FIG. 6, an operational block diagram showing the hydroponics system Z conducting initial nutrient solution preparation and delivering the nutrient solution to each of the sub-systems 2, an operational block diagram showing a quality inspection of the nutrient solution in each of the sub-systems 2, and an operational block diagram showing an adjustment of the nutrient solution in each of the sub-systems 2 are shown. Since FIG. 4 to FIG. 6 respectively illustrate different operational modes of the hydroponics system Z, for the purpose of clear illustration, a number of components which are not used in these modes are omitted. However, the omission of components means the components that are not used in the operational modes, rather than not included in the operational modes.

First, referring to FIG. 4, when starting hydroponics, a nutrient solution to be used in the sub-systems 2 need to be prepared. Therefore, a user can operate the main system 1 to initiate a nutrient preparation procedure, in which desired quality parameters of the nutrient solution required for a specific type of plants which are stored in the control module 14 are selected. After receiving a command selected by the user (such as the type of plants selected by the user), the control module 14 can start the dosing pump 131 of the dosing device 13, so as to pump a nutrition solution, an acid solution, and/or an alkali solution to the nutrient solution preparing device 11 from at least on of the nutrition suppliers 132A, 132B, the acid supplier 133A, and alkali supplier 133B. If necessary, the control module 14 can be configured to pump pure water for diluting the nutrient solution from the pure water source 4.

After the nutrition solution, at least one of the acid solution and the alkali solution, and the pure water are fully mixed in the nutrient solution preparing device 11 by the stirring device to form the nutrient solution, at least a portion of the nutrient solution is introduced into the water quality analysis device 12 for analysis and analyzed quality parameters are compared with predetermined quality parameters stored in the control module 14. If the analyzed quality parameters match with the predetermined quality parameters, the prepared nutrient solution is then delivered to the circulation pipe system 3. If the analyzed quality parameters does not match with the predetermined quality parameters, the control module 14 would control the dosing pump 131 to pump the nutrition solution, acid solution, alkali solution, or pure water to the nutrient solution preparing device 11, so as to conduct another procedure for preparation and mixing of the nutrient solution. Afterwards, at least a portion of the adjusted nutrient solution is delivered to the water quality analysis device 12 for quality analysis, and such a procedure can be repeated until the analyzed quality parameters of the nutrient solution match with the predetermined quality parameters.

After the preparation of the nutrient solution is completed, the main system 1 is configured to deliver the nutrient solution to each of the sub-systems 2 through the circulation pipe system 3. Specifically, the first valve V1, the second valve V2, and the third valve V3 are opened, and the fluid communication between the nutrient solution preparing device 11 and the at least one hydroponics region 21 of the sub-system 2 is formed by the first circulation pipe 31 and the branch pipe 32. Then, the first circulation pump 33 is driven to deliver the nutrient solution from the nutrient solution preparing device 11 to the solution storage region 22 of the sub-system 2 through the first circulation pipe 31 and the branch pipe 32. Moreover, when the nutrient solution received in the solution storage region 22 has reached a certain quantity, the second circulation pump 24 can be driven to deliver the nutrient solution to each of the hydroponics region 21.

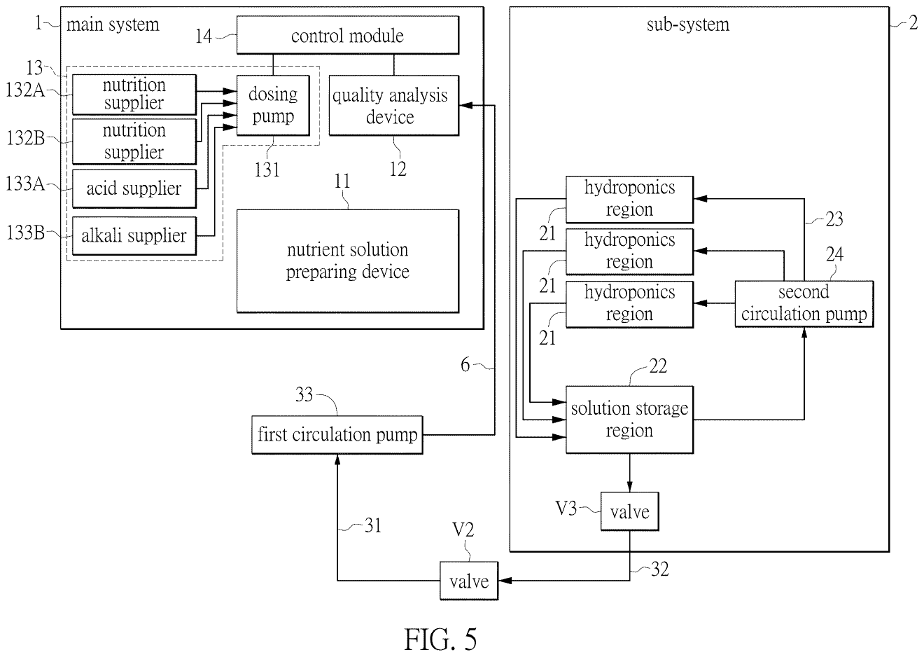

Referring to FIG. 5, during the process of hydroponics, the quality of the nutrient solution in each of the sub-systems 2 need to be inspected regularly, so as to confirm whether the nutrient solution is suitable for planting or contains a sufficient amount of nutrition ingredients. In this operation, the first valve V1 is closed to block the fluid communication between the nutrient solution preparing device 11 and the first circulation pipe 31, and the fluid communication between the main system 1 and the first circulation pump 33 is formed through the sampling pipe 6 as the second valve V2 and the third valve V3 are opened. In this mode, the fluid communication between the solution storage region 22 of the sub-system 2 and the water quality analysis device 12 is formed through the branch pipe 32, the first circulation pipe 31, and the sampling pipe 6, and the first circulation pump 33 is driven to pump at least a portion of the nutrient solution to the water quality analysis device 12 for quality analysis. If the quality parameters of the nutrient solution are determined as matching with the predetermined quality parameters, other fluid delivering operations will not be required, and the second valve V2 and the third valve V3 would be closed.

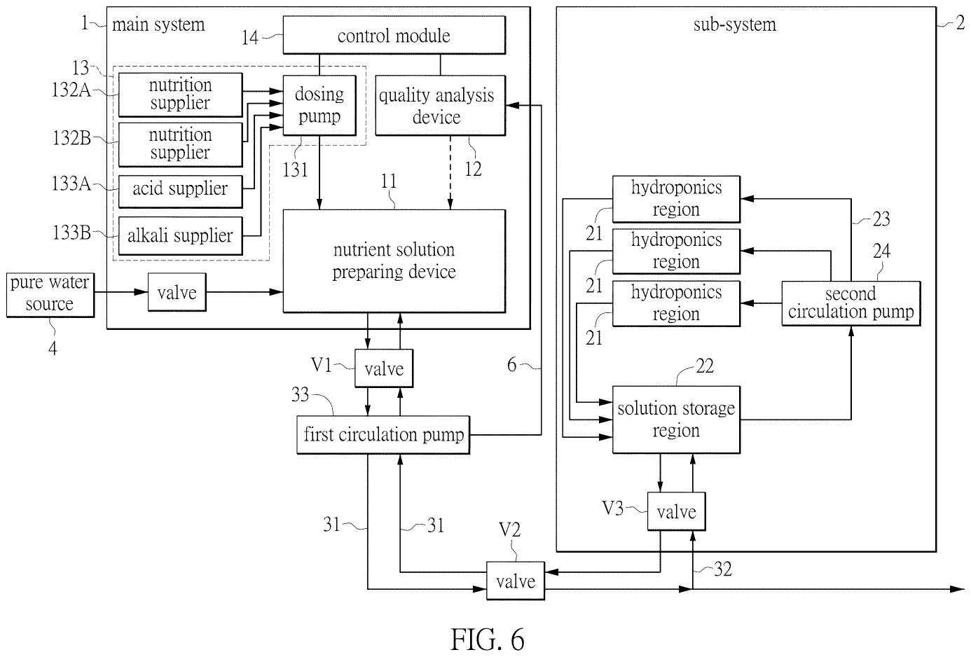

On the other hand, in FIG. 5, if the quality of the nutrient solution used in the sub-system 2 is determined as need for adjustment (such as an adjustment of pH value) or replenishment of nutrition ingredients, the nutrient solution in the sub-system 2 would be delivered to the main system 1 for adjustment. Referring to FIG. 6, the first valve V1, the second valve V2, and the third valve V3 are opened, so as to form the fluid communication between the solution storage region 22 of the sub-system 2 and the nutrient solution preparing device 11 of the main system 1 through the branch pipe 32 and the first circulation pipe 31. Then, the first circulation pump 33 is driven to pump the nutrient solution from the solution storage region 22 to the nutrient solution preparing device 11. The control module 14 can decide what kind of adjustment should be made to the nutrient solution according to differences between the quality parameters sensed by the water quality analysis device 12 and the predetermined quality parameters, and can accordingly control the dosing pump 131 of the dosing device 13 to pump a nutrition solution in one of the nutrition suppliers 132A, 132B and an acid or alkali solution in the acid supplier 133A or the alkali supplier 133B, so as to adjust and mix the nutrient solution.

After the adjustment and mixing of the nutrient solution is completed, the nutrient solution can be delivered to the water quality analysis device 12 for quality analysis, so as to confirm that the nutrient solution has the predetermined quality parameters. Then, the adjusted nutrient solution is delivered back to the solution storage region 22 of the sub-system 2 through the circulation pipe system 3 for reuse.

In addition, in an embodiment not illustrated in the figures, if the nutrient solution in the sub-system 2 is determined as being unsuitable for use once more (e.g., containing excessive wastes, pollutants, bacteria, viruses or other substances that can negatively affect the growth of the plants), the first valve V1 is closed and the second valve V2 and the third valve V3 are opened, and the first circulation pump 33 is driven to discharge the nutrient solution to the waste water place 5. Then, a new nutrient solution can be prepared according to the operation as shown in FIG. 4, and can be delivered to the sub-system 2 for use.

The above paragraphs describe the structure, the technical features, the connection relationships, and the operational modes of the hydroponics system Z of the present disclosure. In addition to the modules and components as described above, the components or modules of the hydroponics system Z of the present disclosure can be optionally expanded. For example, a humidity sensing and adjusting module, a carbon dioxide sensing module, and a water temperature sensing module can be added to the system. It should be understood that although the above paragraphs and drawings only take one or two sub-systems for description, in practice, the number of the sub-systems 2 can be between 1 to 10. In this way, the hydroponics system Z of the present disclosure can realize a “one-to-many” plant growth management with high efficiency through a fluid connection and information transmission between a single main system 1 and a plurality of sub-systems 2.

### Beneficial Effects of the Embodiment

In conclusion, in the one-to-many hydroponics system provided by the present disclosure can realize a one-to-many planting management, in which a planting area can be expanded without additional manpower costs by an automatic system for monitoring and adjusting a nutrient solution. Furthermore, the sub-systems can be used to grow different plants and correspondingly provide desired nutrients and growth conditions to the plants. The aforementioned beneficial effects can be achieved by the technical features as follows: the one-to-many hydroponics system includes a main system, a plurality of sub-systems, and a circulation pipe system, the main system is configured to cooperate with the sub-systems through the circulation pipe system, each of the sub-systems includes at least one hydroponics region and a solution storage region that is configured to store nutrient solution and supply the nutrient solution to the at least one hydroponics region. Specifically, the main system includes a nutrient solution preparing device, a water quality analysis device, a dosing device, and a control module. The nutrient solution preparing device is in fluid communication with the solution storage region of each of the sub-systems through the circulation pipe system, so as to recycle the nutrient solution which has been used in any one of the sub-systems. The water quality analysis device is in fluid communication with the circulation pipe system, so as to analyze quality parameters of the recycled nutrient solution. The dosing device is in fluid communication with the nutrient solution preparing device, so as to adjust a nutrition concentration of the recycled nutrient solution according to the quality parameters. The control module is in signal communication with the dosing device and the water quality analysis device.

Compared to conventional hydroponics management manners and apparatus, the hydroponics system of the present disclosure is capable of managing a plurality of hydroponics regions for planting in a one-to-many manner, and can manage the growth conditions of various types of plants at the same time. As a result, there are no requirements for specific plants to use an exclusive planting parameter monitoring and adjusting system, and a nutrient solution for other types of plants, thus greatly reducing planting costs can and improving plant growth quality. Moreover, the main system is stored with planting parameters of plural types of plants in different growing states, a user who does not have any planting experience can still perform planting by operating the main system, in which operations of the main system are simple and easy to control. In addition, the hydroponics system of the present disclosure also has flexibility of being expanded with other functional modules, and can satisfy professional and customized requirements of the user.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

1. A one-to-many hydroponics system, comprising:
a plurality of sub-systems, each of the sub-systems including:
at least one hydroponics region; and
a solution storage region configured to store nutrient solution, and supply the nutrient solution to the at least one hydroponics region;
a circulation pipe system; and
a main system, including:
a nutrient solution preparing device being in fluid communication with the solution storage region of each of the sub-systems through the circulation pipe system, wherein the nutrient solution preparing device is configured to recycle the nutrient solution that has been used in any one of the sub-systems;
a water quality analysis device being in fluid communication with the circulation pipe system, wherein the water quality analysis device is configured to extract at least a portion of the nutrient solution that has been used in any one of the sub-systems or at least a portion of the nutrient solution in the nutrient solution preparing device, and analyze quality parameters of the nutrient solution introduced from any one of the sub-systems or the nutrient solution preparing device; and
a dosing device being in fluid communication with the nutrient solution preparing device, wherein the dosing device is configured to adjust a nutrition concentration of the recycled nutrient solution according to the quality parameters;
wherein the main system is configured to cooperate with the sub-systems through the circulation pipe system to grow a plant.

2. The one-to-many hydroponics system according to claim 1, wherein the dosing device further includes at least one nutrition supplier, an acid supplier, an alkali supplier, and a dosing pipe system, the at least one nutrition supplier, the acid supplier, and the alkali supplier are in fluid communication with the nutrient solution preparing device through the dosing pipe system, and the dosing pipe system is provided with a dosing pump.

3. The one-to-many hydroponics system according to claim 2, wherein the nutrient solution preparing device includes a mixing tank and a stirring device disposed in the mixing tank, and the at least one nutrition supplier, the acid supplier, and the alkali supplier are in fluid communication with the mixing tank through the dosing pipe system, so as to mix at least one nutrition, an acid, and/or an alkali fed into the mixing tank with the recycled nutrient solution through an operation of the dosing pump.

4. The one-to-many hydroponics system according to claim 3, wherein the circulation pipe system includes a first circulation pipe, a plurality of branch pipes, and a first circulation pump; wherein the first circulation pipe is connected to the mixing tank to form a main circulation loop, the branch pipes extend from the first circulation pipe, and are respectively in fluid communication with the solution storage regions of the sub-systems, and the first circulation pump is installed on the first circulation pipe; wherein the water quality analysis device is in fluid communication with the first circulation pipe through a sampling pipe.

5. The one-to-many hydroponics system according to claim 1, wherein each of the sub-systems includes a second circulation pipe and a second circulation pump, the second circulation pipe is connected to the at least one hydroponics region to form a secondary circulation loop, and the second circulation pump is installed on the second circulation pipe, so as to circulate the nutrient solution between the solution storage region and the at least one hydroponics region.

6. The one-to-many hydroponics system according to claim 1, wherein each of the sub-systems includes at least one growing light source, and the at least one growing light source is configured to irradiate the at least one hydroponics region, so as to provide an optical wavelength for growing the plant.

7. The one-to-many hydroponics system according to claim 6, wherein each of the sub-systems includes at least one air flow generator, and the at least one air flow generator corresponds in position to the at least one hydroponics region.

8. The one-to-many hydroponics system according to claim 7, wherein each of the sub-systems includes at least one image capturing device, and the at least one image capturing device corresponds in position to the at least one hydroponics region, so as to capture images of the plant.

9. The one-to-many hydroponics system according to claim 8, wherein each of the sub-systems includes a sensing module which includes an air temperature and humidity sensor, a carbon dioxide concentration sensor, and a water temperature sensor, so as to monitor growing environment parameters of the plant.

10. The one-to-many hydroponics system according to claim 1, wherein the plant growing in the at least one hydroponics region of one of the sub-systems is different from the plant growing in the at least one hydroponics region of another one of the sub-systems.

11. The one-to-many hydroponics system according to claim 1, wherein the main system is in fluid communication with an external water source, and the nutrient solution preparing device is configured to receive water for preparing the nutrient solution.

12. The one-to-many hydroponics system according to claim 4, wherein the first circulation pump is connected to an external waste water pipe, so that when the nutrient solution in at least one of the sub-systems becomes unsuitable for use, the nutrient solution is discharged from the at least one of the sub-systems through the external waste water pipe.
